(19) United States
(12) Patent Application Publication
(10) Pub. No.: US 2022/0035924 A1
(43) Pub. Date: Feb. 3, 2022

(54) SERVICE TRUST STATUS

(71) Applicant: Hewlett-Packard Development Company, L.P., Spring, TX (US)

(72) Inventors: Edson Schardosim Behnck, Porto Alegre (BR); Ronaldo Rodrigues Ferreira, Porto Alegre (BR); Joao Luis Prauchner, Porto Alegre (BR); Juliano Francisco Cagnini Ciocari, Porto Alegre (BR)

(73) Assignee: Hewlett-Packard Development Company, L.P., Spring, TX (US)

(21) Appl. No.: 17/288,555

(22) PCT Filed: Apr. 18, 2019
(86) PCT No.: PCT/US2019/028060

§ 371 Date: Apr. 25, 2021

(51) Int. Cl. G06F 21/57; G06F 21/60; G06F 21/64

(52) U.S. Cl. CPC G06F 21/572; G06F 21/602; G06F 21/64; G06F 21/606

(57) ABSTRACT

An example computing device for determining a service trust status can include a processing resource and a memory resource storing instructions thereon, the instructions executable by the processing resource to: receive, at a service, a token and a current value of a counter from a firmware, generate, at the service, an encrypted message utilizing the token and the current value of the counter, provide the encrypted message to an application associated with the service, determine, at the firmware, an authenticity of the encrypted message provided to the application, and send, from the firmware, a trust status of the service to the application.

### BACKGROUND

A computing device can include devices that utilize a processing resource to execute instructions to perform particular functions. Computing devices can utilize firmware such as a basic input/output system (BIOS) to perform certain functions, utilize applications to perform certain functions, and/or utilize services to perform certain functions. In some examples, the computing device can utilize applications and/or services from third parties.

### BRIEF DESCRIPTION OF THE DRAWINGS

FIG. 1 is an example system to determine a trust status of a service consistent with the present disclosure.

FIG. 2 is an example device to determine a trust status of a service consistent with the present disclosure.

FIG. 3 is an example computer readable storage medium to determine a trust status of a service consistent with the present disclosure.

FIG. 4 is an example system to determine a trust status of a service consistent with the present disclosure.

FIG. 5 is an example flow diagram to determine a trust status of a service consistent with the present disclosure.

### DETAILED DESCRIPTION

Devices, such as computing devices, can include a plurality of features to perform a plurality of functions. For example, devices can include components, firmware, and/or software such as a basic input/output system (BIOS) or a unified extensible firmware interface (UEFI), an operating system (OS), applications, and/or services. In this example, each of the features can be utilized to perform particular functions for the device and/or perform a particular portion of a function for the device. In some examples, the devices can establish a trust status with other features prior to interacting with the other features. For example, an application can interact with different types of services that are provided by different organizations. In this example, the services can potentially be a non-trusted service that can be utilized to perform unwanted functions on the device. Thus, it can be beneficial to ensure that the services are trusted services that are not going to damage the device or the functions of the device.

As used herein, firmware can include instructions that are executable by a processing resource to control input and/or output functions of the device. For example, a BIOS or UEFI can be computer readable instructions in firmware that can control the input and output operations of the device. As used herein, an application can include instructions that are executed by a processing resource to perform a group of coordinated functions or tasks for the device. For example, an application can be a computer application that can be utilized to perform a particular function (e.g., text document, spreadsheet document, game, etc.). As used herein, a service can include instructions that are executed by a processing resource to perform a set of operations or functions that can be retrieved and/or utilized by different devices. In some examples, a service can be referred to as a process, an instance, a software functionality, or a mechanism to enable access to a number of functions. For example, a service can be instructions that can be retrieved by a device through a network, such as the internet, to perform a defined function for the device. In this example, the service can be available to a plurality of other devices.

The present disclosure includes systems, devices, and computer readable mediums for determining and/or confirming a trust status of a service. The present disclosure includes utilizing a firmware of a system or device to provide services determined to be a trusted service with a token and a current value of a counter. The service can then generate an encrypted message to an application of the system or device utilizing the token and the current value of the counter. In some examples, the application can send or forward the received encrypted message from a service to the firmware. In these examples, the firmware can generate a corresponding encrypted message utilizing the token, current value of the counter, and the message portion to compare to the received encrypted message forwarded by the application. In these examples, the corresponding encrypted message can be compared to the encrypted message received from the application.

In these examples, the firmware can determine that the service that provided the encrypted message is a trusted service when the encrypted message matches the corresponding encrypted message. The firmware can then provide a message to the application that indicates the trust status of the application. In this way, the firmware can be utilized to authenticate a service to be utilized with an application and provide a confirmation to the application that the service is a trusted service.

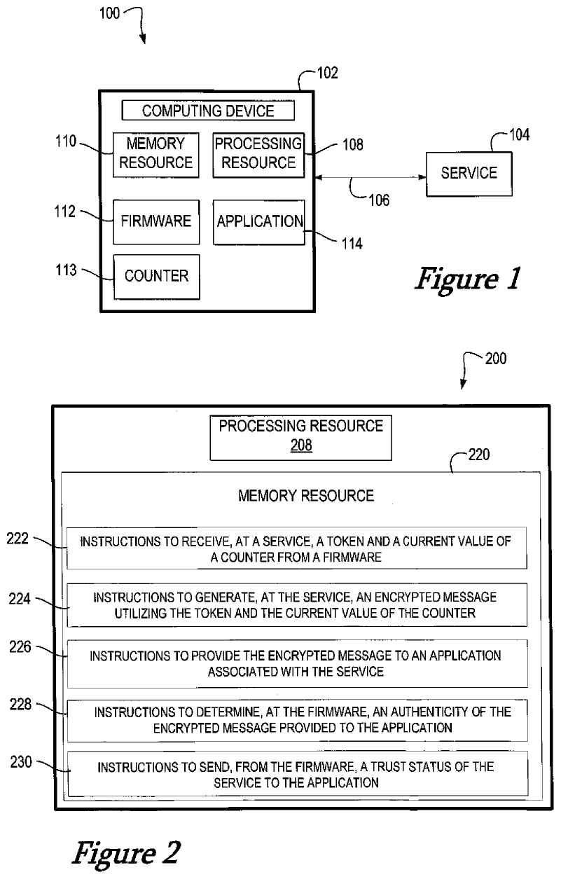

FIG. 1 is an example system 100 to determine a trust status of a service 104 consistent with the present disclosure. The system 100 can include a computing device 102 that includes a memory resource 110, a processing resource 108, a firmware 112, a counter 113, and/or an application 114. A computing device 102, as used herein includes a device (e.g., physical device) that includes instructions stored on the memory resource 110 and executed by the processing resource 108 to perform particular functions. In some examples, the computing device 102 can utilize a service 104. In some examples, the service 104 can be an external service that is communicatively coupled to the computing device 102 through a communication channel 106. In other examples, the service 104 can be stored by the memory resource 110 and executed by the processing resource 108.

Processing resource 108, as used herein, can include a number of processing resources capable of executing instructions stored by a memory resource 110. The instructions (e.g., machine-readable instructions (MRI)) can include instructions stored on the memory resource 110 and executable by the processing resource 108 to implement a desired function (e.g., determining a trust status of a service 104, etc.). The memory resource 110, as used herein, can include a number of memory components capable of storing non-transitory instructions that can be executed by processing resource 110. Memory resource 110 can be integrated in a single device or distributed across multiple devices. Further, memory resource 110 can be fully or partially integrated in the same device as processing resource 108 or it can be separate but accessible to that device and processing resource 108. Thus, it is noted that the computing device 102 can be implemented on an electronic device and/or a collection of electronic devices, among other possibilities.

In some examples, the computing device 102 can utilize the firmware 112 to provide the service 104 with a token and a current value of a counter 113 to the service 104. In some examples, the computing device 102 can utilize the firmware 112 to send the token and the current value of the counter 113 to the service 104 though a communication channel 106. In some examples, the communication channel 106 can be a wired or wireless communication channel. In other examples, the communication channel 106 can be network or a connection to a network such as the Internet.

In some examples, the service 104 can generate an encrypted message utilizing the token and the current value of the counter 113 provided by the firmware 112. As used herein, an encrypted message can include a message that has been encrypted with a particular type of encryption technique. In some examples, the encrypted message can be a hash-based message authentication code (HMAC) that can include a message. As used herein, a HMAC can be a type of message authentication code (MAC) involving a cryptographic hash function and a secret cryptographic key. In some examples, the encrypted message can be a sequence of bytes where the bytes of the token are used as a prefix and the current value of the counter 113 is a suffix. In some examples, the service 104 can utilize a decrypted shared secret as a key. In some examples, the decrypted shared secret can be provided or shared by the firmware 112 when the firmware 112 has authenticated the service 104.

In some examples, the service 104 can send the encrypted message to the application 114. In some examples, the service 104 can send the encrypted message through the communication channel 106. In other examples, the service 104 can be stored within the memory resource 110 and the service 104 can send the encrypted message through an internal communication channel of the computing device 102. In some examples, the application 114 can receive the encrypted message from the service 104 and forward the encrypted message to the firmware 112 to authenticate the service 104 and/or determine a trust status of the service 104. In some examples, the application 114 can determine whether a trust status exists for the service 104 prior to forwarding or sending the encrypted message to the firmware 112. For example, the application 114 can determine if the firmware 112 has previously provided a trust status for the service 104. In this example, the application 114 can send the encrypted message to the firmware 112 if the application 114 has not obtained a trust status from the firmware 112.

In some examples, the firmware 112 can receive the encrypted message from the application 114 when the application 114 is requesting a trust status for the service 104. In some examples, the firmware 112 can utilize the decrypted shared secret key provided to the service 104, the token provided to the service 104, and the current value of the counter 113 to generate a corresponding encrypted message or corresponding HMAC. In these examples, the firmware 112 can compare the corresponding encrypted message to the encrypted message received from the application 114 that was provided by the service 104. In these examples, the firmware 112 can determine that the service 104 is a “trusted service” when the encrypted message from the service 104 matches the corresponding encrypted message generated by the firmware 112. Similarly, the firmware 112 can determine that the service 104 is a “non-trusted service” when the encrypted message from the service 104 does not match the corresponding encrypted message generated by the firmware 112.

As used herein, a trusted service can be a service, such as service 104, that is verified to provide a particular function, verified to be from a particular organization, and/or verified to be a non-harmful service. As used herein, a non-trusted service can include a service, such as service 104, that is not verified to be a non-harmful service to the computing device 102. In some examples, a non-trusted service can be prevented from interacting with the computing device 102. For example, the firmware 112 can send a message to the application 114 to ignore the encrypted message from the service 104 when the encrypted message from the service 104 does not match the corresponding encrypted message generated by the firmware 112. In this way, the firmware 112 can prevent the application 114 from executing instructions provided by the service 104 when the service 104 is a non-trusted service.

In some examples, the firmware 112 can provide a trust status message to the application 114 based on the comparison of the encrypted message provided by the service and the corresponding encrypted message generated by the firmware 112. As described herein, the trust status message can indicate whether the service 104 is a trusted service or a non-trusted service. In this way, the firmware 112 can be utilized to authenticate a trust status of a service, such as the service 104.

FIG. 2 is an example device 220 to determine a trust status of a service consistent with the present disclosure. In some examples, the device 220 can include similar elements as system 100 as referenced in FIG. 1. For example, the device 220 can include a processing resource 208 and a memory resource 210 storing instructions 222, 224, 226, 228, 230, 232.

Processing resource 208, as used herein, can include a number of processing resources capable of executing instructions stored by a memory resource 210. The instructions (e.g., machine-readable instructions (MRI)) can include instructions stored on the memory resource 210 and executable by the processing resource 208 to implement a desired function (e.g., determine an authenticity of the encrypted message provided to an application from a service, etc.). The memory resource 210, as used herein, can include a number of memory components capable of storing non-transitory instructions that can be executed by processing resource 208.

The memory resource 210 can be in communication with the processing resource 208 via a communication link (e.g., path). The communication link can be local or remote to an electronic device associated with the processing resource 208. The memory resource 210 includes instructions 222, 224, 226, 228, 230, 232. The memory resource 210 can include more or fewer instructions than illustrated to perform the various functions described herein. In some examples, instructions (e.g., software, firmware, etc.) 222, 224, 226, 228, 230, 232 can be downloaded and stored in memory resource 210 (e.g., MRM) as well as a hard-wired program (e.g., logic), among other possibilities.

Instructions 222, when executed by a processing resource such as processing resource 208 can receive, at a service, a token and a current value of a counter from a firmware. In some examples, the service can include instructions that can be retrieved by the computing device 102 to perform a particular function. In some examples, the service can be authenticated by the firmware and the firmware can send the service the token and the current value of the counter when the firmware has authenticated the service. As described herein, the firmware can authenticate the service when the firmware determines that the service is a trusted service.

As used herein, the token can be a keyword, an operator, a particular series of bits that can be a secret between the firmware and the service. As used herein, the counter can be a processing resource that can include a current value that can represent a quantity of executions or quantity of interactions. For example, the current value of the counter can increase by an increment (e.g., increment of one, etc.) for each message generated by the service. In this way, a non-trusted service can be detected or identified even when the non-trusted service obtains the token for encrypting or decrypting messages. For example, the non-trusted service can obtain the token, but without the correct current value of the counter, the non-trusted service can be identified by the firmware when the firmware compares an encrypted message utilizing the token and the current value of the counter.

Instructions 224, when executed by a processing resource such as processing resource 208 can generate, at the service, an encrypted message utilizing the token and the current value of the counter. In some examples, the service can start generating the encrypted message by incrementing the current value of the counter. In these examples, the service increases the current value of the counter by an increment (e.g., value of 1, etc.) and utilizes the incremented current value of the counter as the current value of the counter. In some examples, the service can construct a series of bytes utilizing the current value of the counter and the token. For example, the service can construct a series of bytes that utilizes the token as a prefix and the current value of the counter as the suffix to generate a token/counter series of bytes.

In some examples, the service can generate an HMAC using a decrypted shared secret as a key. In these examples, the service can receive the decrypted shared secret from the firmware when the firmware authenticates the service as a trusted service. In some examples, the service can construct a final encrypted message utilizing the generated HMAC as a prefix and the generated token/counter series as a suffix. In this way, the service can generate an encrypted message that includes a message portion encrypted with a shared secret value between the firmware and the service, as well as the current value of the counter and the token.

Instructions 226, when executed by a processing resource such as processing resource 208 can provide the encrypted message to an application associated with the service. In some examples, the encrypted message generated by the service can be sent to the application through a communication channel. For example, the encrypted message can be sent from the service to the application through a communication channel such as a wired or wireless communication channel. In some examples, the service can establish a communication session with the application to interact with the application during operation. For example, the service can utilize a function of the application and establish a communication session through the communication channel to utilize the function of the application.

In some examples, the application can forward the generated encrypted message to the firmware before the application establishes trust with the service. In some examples, the encrypted message can be message to establish trust with the application. For example, the application can receive the encrypted message from the service. In this example, the application may not know a trust status of the service. Thus, in this example, the application can forward or send the generated encrypted message to the firmware to have the firmware determine the trust relationship of the service before responding to the service or performing instructions associated with the encrypted message.

Instructions 228, when executed by a processing resource such as processing resource 208 can determine, at the firmware, an authenticity of the encrypted message provided to the application. In some examples, determining the authenticity of the encrypted message can include determining a trust status of the service that generated the encrypted message. For example, the firmware can receive the encrypted message from the application and determine whether the received encrypted message was generated by a trusted service or a non-trusted service. In some examples, the instructions to determine the authenticity of the encrypted message includes instructions to generate, at the firmware, a separate encrypted message utilizing the token and the current value of the counter. In some examples, the separate encrypted message can be a corresponding encrypted message to the encrypted message generated by the service. For example, the firmware can utilize the same or similar technique to generate the separate encrypted message as the service utilized to the generate the encrypted message. In this way, the separate encrypted message should match the encrypted message generated by the service.

In some examples, the memory resource 210 can include instructions to compare, at the firmware, the generated encrypted message received by the application to the generated separate encrypted message from the firmware. As described herein, the firmware can compare the encrypted message generated by the service to an encrypted message generated by the firmware utilizing the same token, current value of a counter, and/or secret key shared between the firmware and the service.

Instructions 230, when executed by a processing resource such as processing resource 208 can send, from the firmware, a trust status of the service to the application. In some examples, the trust status of the service can be an indication of whether the service is a trusted service or a non-trusted service. In some examples, the trust status of the service is a trusted service when the encrypted message and the separate encrypted message match. In some examples, the trust status can be a message that indicates the trust status of the service. In additional examples, the trust status can be a message that indicates a time period to trust the service. For example, the trust status can indicate a time period to allow a communication session between the service and the application.

In some examples, the application can receive the trust status of the service and either initiate a communication session with the service or ignore the encrypted message received from the service. In some examples, the application can execute instructions associated with the encrypted message when the trust status from the firmware indicates that the service is a trusted service. In other examples, the application can ignore the instructions associated with the encrypted message when the trust status from the firmware indicates that the service is a non-trusted service.

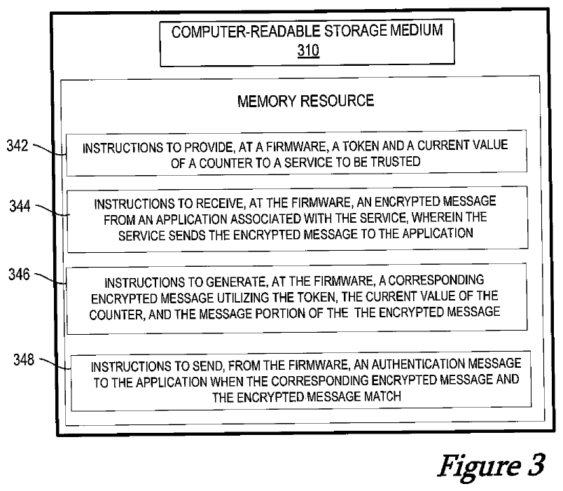

FIG. 3 is an example computer readable storage medium 310 to determine a trust status of a service consistent with the present disclosure. In some examples, the computer readable storage medium 310 can be utilized by a device such as device 220 as referenced in FIG. 2 and/or utilized by a system such as system 100 as referenced in FIG. 1. For example, the computer readable storage medium 310 can be a memory resource storing instructions 342, 344, 346, 348.

The computer readable storage medium 310 can be in communication with a processing resource (e.g., processing resource 208 as referenced in FIG. 2, etc.) via a communication link (e.g., path). The computer readable storage medium 310 can include instructions 342, 344, 346, 348. The computer readable storage medium 310 can include more or fewer instructions than illustrated to perform the various functions described herein. In some examples, instructions (e.g., software, firmware, etc.) 342, 344, 346, 348 can be downloaded and stored in computer readable storage medium 310 (e.g., MRM, CRM, etc.) as well as a hard-wired program (e.g., logic), among other possibilities.

Instructions 342, when executed by a processing resource can provide, at a firmware, a token and a current value of a counter to a service to be trusted. In some examples, the firmware can authenticate the service. As described herein, the firmware can determine a trust status of the service by determining a provider or creator of the service. In some examples, the firmware can provide the token and the current value of the counter when the firmware determines that the service is a trusted service. In some examples, the firmware can send the token and the current value to the service through a communication channel.

Instructions 344, when executed by a processing resource can receive, at the firmware, an encrypted message from an application associated with the service, wherein the service sends the encrypted message to the application. As described herein, the service can generate the encrypted message utilizing the token and the current value from the firmware. In some examples, the application can receive the encrypted message from the service and the application can forward or send the encrypted to the firmware to authenticate the encrypted message is associated with a trusted service. In some examples, the application can send the encrypted message to the firmware before opening or utilizing the encrypted message from the service. For example, the application can treat the encrypted as a message from a non-trusted service until the firmware provides a trust status message to the application. In this way, the application may prevent the encrypted message from performing unwanted functions if the encrypted message was from a non-trusted service (e.g., encrypted message is a virus provided by a non-trusted service, etc.).

Instructions 346, when executed by a processing resource can regenerate, at the firmware, a corresponding encrypted message utilizing the token, the current value of the counter, and the message portion of the encrypted message. As described herein, the firmware can determine whether the service that generated the encrypted message by generating a corresponding encrypted message or HMAC utilizing the token, the current value of the counter, and the message portion of the encrypted message. As described herein, the firmware can utilize the same or similar encryption method to generate the corresponding encrypted message or HMAC, such that the corresponding encrypted message or HMAC will match the encrypted message generated by the service when the service is a trusted service that was previously authenticated by the firmware and provided with the correct token and current value of the counter.

In some examples, the token is utilized as a prefix and the current value of the counter is utilized as a suffix for the encrypted message and the corresponding encrypted message or HMAC. As described herein, the encryption method utilized by the service to generate the encrypted message and utilized by the firmware to generate the corresponding encrypted message or HMAC can utilize the token as a prefix and the current value of the counter as a suffix. The combination of the token and current value can be used as a suffix to an encrypted message portion or HMAC to generate the final encrypted message.

Instructions 348, when executed by a processing resource can send, from the firmware, an authentication message to the application when the corresponding encrypted message or HMAC and the encrypted message match. As described herein, the service can be determined to be a trusted service by the firmware when the encrypted message generated by the service matches the corresponding encrypted message or HMAC generated by the firmware. The firmware can send the authentication message to the application when the firmware determines that the service is a trusted service.

In some examples, the authentication message can include the trust status of the service along with additional instructions for the application. For example, the authentication message can include a quantity of time the application is allowed to trust the service. In this example, the quantity of time can allow the application to trust the service or treat the service as a trusted service for a particular period. In some examples, the authentication message includes instructions for the application to allow a communication channel to remain open with the service for a period of time. For example, the communication channel between the application and the service can remain open for the quantity of time determined by the firmware. In other examples, the communication channel can remain open for a duration of a communication session between the application and the service.

In other examples, the authentication message can include instructions to trust the service for a particular communication session. That is, the application can treat the service as a trusted service until the communication session between the application and the service is terminated. In this example, the application and service can interact or exchange messages through a communication channel without interacting with the firmware. When the communication session ends, a first encrypted message from the same service to initiate a new communication session may have to be authenticated as described herein.

In some examples, the computer readable storage medium 310 can include instructions to update, at the firmware, the current value of the counter when the authentication message is sent to the application. As described herein, the firmware can receive the encrypted message from the application. The firmware can update the current value of the counter prior to generating the corresponding encrypted message or HMAC to account for the service updating the counter prior to generating the encrypted message. In this way, the current value of the counter for the firmware will be same value as the current value of the counter for the service.

In some examples, the application responds to the encrypted message of the service when the application receives the authentication message from the firmware. As described herein, the encrypted message can include instructions for the application to perform a particular function or provide particular access to the service. In some examples, the application can respond to the service, perform the particular function, and/or provide particular access to the service when the application receives the authentication message that indicates that the service is a trusted service.

In some examples, the computer readable storage medium 310 can include instructions to send, from the firmware, a non-authentication message to the application when the corresponding encrypted message or HMAC and the encrypted message do not match, wherein the non-authentication message indicates that the service is not a trusted service for the application. In some examples, the non-authentication message can be a message from the firmware that indicates to the application that the service is a non-trusted service that should not be trusted. In some examples, the non-authentication message can instruct the application to ignore the encrypted message and/or treat the encrypted message as a threat to system security. For example, the non-authentication message can indicate to the application to stop communication with the service.

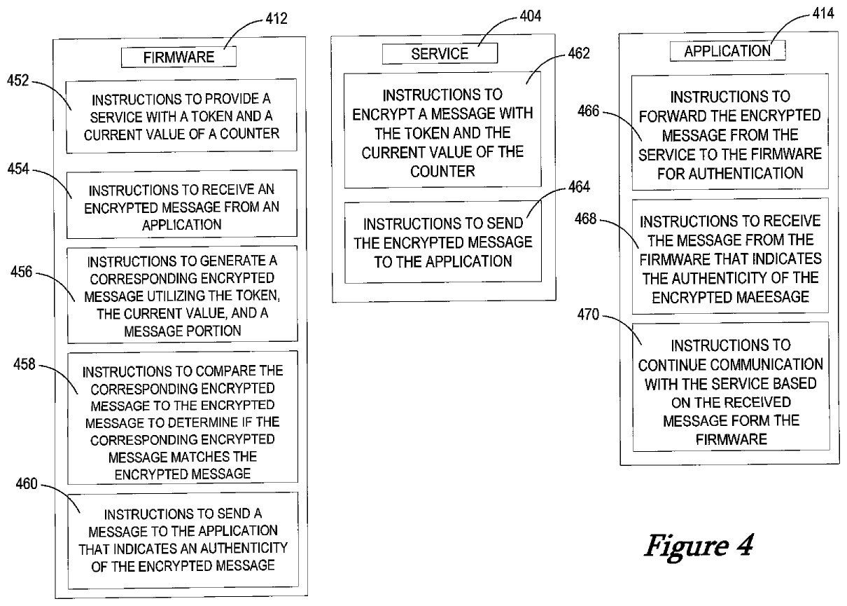

FIG. 4 is an example system 400 to determine a trust status of a service 404 consistent with the present disclosure. In some examples, the system 400 can include the same or similar elements as system 100 as referenced in FIG. 1. For example, the system 400 can include a firmware 412, a service 404, and/or an application 414. In some examples, the system 400 can illustrate different features of a computing system or computing device. For example, the firmware 412, service 404, and/or application 414 can be utilized or provided by a computing device or computing system.

In some examples, the system 400 can include instructions executed by a processor for the different features (e.g., firmware 412, service 404, application 414, etc.). For example, the firmware 412 can include instructions 452, 454, 456, 458, 460 that are executable by a processing resource to perform functions associated with the firmware 412. In this example, the service 404 can include instructions 462, 464 that are executable by a processing resource to perform functions associated with the service 404. Furthermore, in this example, the application 414 can include instructions 466, 468, 470 that are executable by a processing resource to perform functions associated with the application 414. In some examples, the instructions associated with each feature can be executed by the same processing resource or the instructions associated with each feature can be executed by different processing resources.

In some examples, the firmware 412 can include instructions 452 that when executed by a processing resource can provide a service with a token and a current value of a counter. As described herein, the firmware 412 can interact with the service 404 to determine if the service 404 is a trusted service or a non-trusted service. For example, the firmware 412 can determine a source or provider of the service 404 and determine whether the source or provider is a trusted source. As used herein, a trusted source can be a provider of services that are deemed to be safe to utilize. When the firmware 412 determines that the service 404 is a trusted service, the firmware 412 sends the token and the current value of the counter to the service 404.

The firmware 412 can include instructions 454 that when executed by a processing resource can receive an encrypted message from an application 414. As described herein, the application 414 can receive an encrypted message from the service 404 that was generated by the service 404 utilizing the token and current value of the counter provided by the firmware 412. As described herein, the application 414 can forward or send the received encrypted message from the service 404 to the firmware 412. In some examples, the application 414 may forward or send the encrypted message to the firmware 412 prior to determining the contents of the encrypted message. In this way, the application 414 can be prevented from interacting with a potentially harmful message from a potentially dangerous service.

The firmware 412 can include instructions 456 that when executed by a processing resource can generate a corresponding encrypted message utilizing the token, the current value, and a message portion. As described herein, the firmware 412 can generate the corresponding encrypted message or HMAC utilizing the same or similar encryption method as the service 404 utilized when generating the encrypted message that was sent to the application 414. In this way, the firmware 412 can confirm that the service 404 that generated the encrypted message is the same service that the firmware 412 authenticated. As described herein, the firmware can authenticate the service 404 and send the service 404 the token and the current value of the counter when the service 404 is a trusted service.

The firmware 412 can include instructions 458 that when executed by a processing resource can compare the corresponding encrypted message or HMAC to the encrypted message to determine if the corresponding encrypted message or HMAC matches the encrypted message. As described herein, the firmware 412 can generate the corresponding encrypted message or HMAC using the same token, current value of the counter, and the message portion provided by the application 414. The corresponding encrypted message or HMAC can be compared to the encrypted message generated by the service 404 to determine if the corresponding encrypted message or HMAC matches the encrypted message. If the token, current value of the counter, and secret used to encrypt the message portion are utilized by the service 404, the corresponding encrypted message or HMAC generated by the firmware 412 should be the same as the encrypted message. Thus, the firmware 412 can validate that the service 404 is a trusted service by comparing the corresponding encrypted message or HMAC generated by the firmware 412 to the encrypted message generated by the service 404.

The firmware 412 can include instructions 460 that when executed by a processing resource can send a message to the application 414 that indicates an authenticity of the encrypted message. As described herein, the encrypted message can be authenticated when the encrypted message matches the corresponding encrypted message or HMAC generated by the firmware 412. Thus, when the firmware 412 authenticates the encrypted message, the firmware 412 can send a message to the application 414 that indicates the encrypted message is from a trusted service such as service 404. In some examples, the message can include additional instructions for the application 414 on how to treat the service 404 that provided the authenticated encrypted message. For example, the message to the application can include instructions to open a communication session with the service 404 for a particular period of time.

In some examples, the service 404 can include instructions 462 that when executed by a processing resource can encrypt a message with the token and the current value of the counter. In some examples, the service 404 can receive the token and the current value of the counter from the firmware 412. As described herein, the service 404 can encrypt a message utilizing a secret key shared between the service 404 and the firmware 412. In some examples, the service 404 can utilize a combination of the token and the current value of the counter as a suffix of the encrypted message and utilize an encrypted message portion utilizing the secret key as a prefix of the encrypted message. Other formats of message encryption could be utilized so long as the service 404 and the firmware 412 are able to generate matching encrypted messages to authenticate and/or validate the service 404 utilizing the token and current value of the counter.

In some examples, the service 404 can include instructions 464 that when executed by a processing resource can send the encrypted message to the application 414. As described herein, the service 404 can send the encrypted message to the application 414 through a communication channel. For example, the service 404 can be communicatively coupled to the application through a wired or wireless connection. In some examples, the service 404 can send the encrypted message to begin a communication session with the application 414. As described further here, the application 414 can utilize the firmware 412 to authenticate the encrypted message and/or the service 404 before continuation or acceptance of the communication session.

In some examples, the application 414 can include instructions 466 that when executed by a processing resource can forward the encrypted message from the service to the firmware 412 for authentication. In some examples, the application 414 can receive the encrypted message from the service 404 and immediately send or forward the message to the firmware 412 for authentication. In some examples, the application 414 may forward the encrypted message before attempting to open or extract information relating to the encrypted message. This can provide an additional layer of protection from unauthorized services and/or providers.

In some examples, the application 414 can include instructions 468 that when executed by a processing resource can receive the message from the firmware 412 that indicates the authenticity of the encrypted message. As described herein, the firmware 412 can determine an authenticity of the service 404 by recreating the encrypted message utilizing the same token and current value of the counter. As described herein, if the encrypted message generated by the service 404 matches the corresponding encrypted message that was recreated by the firmware 412, the firmware 412 can send a message to the application 414 indicating that the service 404 is a trusted service.

In some examples, the application 414 can include instructions 470 that when executed by a processing resource can continue communication with the service 404 based on the received message from the firmware 412. In some examples, the instructions 470 can include instructions to continue communication with the service 404 for a particular quantity of time. As described herein, the communication session between the service 404 and the application 414 can be extended or accepted by the application 414 when the firmware 412 authenticates the encrypted message as being from a trusted service such as service 404.

In some examples, the application 414 can include instructions that when executed by a processing resource can ignore a command associated with the encrypted message when the corresponding encrypted message or HMAC does not match the encrypted message. As described herein, the firmware 412 can determine that the encrypted message is from a non-trusted service when the encrypted message and the recreated corresponding encrypted message do not match. In this example, the message from the firmware 412 can indicate to the application 414 that the service that generated the encrypted message is not to be trusted and should be avoided. In response, the application 414 can discontinue communication with the non-trusted service and discard the encrypted message to avoid potential damage.

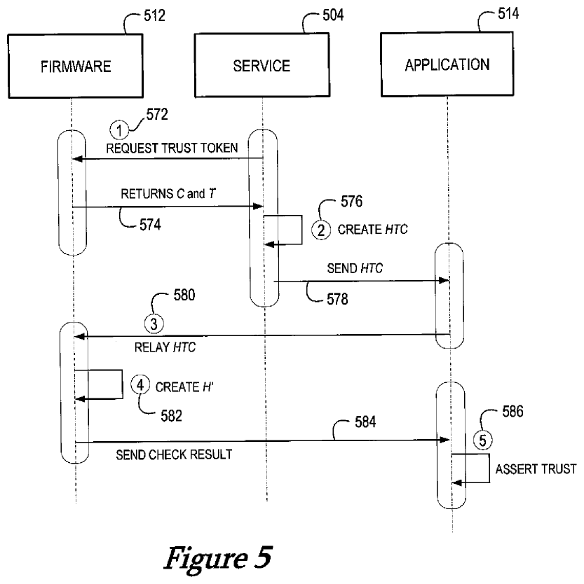

FIG. 5 is an example flow diagram 501 to determine a trust status of a service 504 consistent with the present disclosure. In some examples, the flow diagram 501 can be executed by a system (e.g., system 100 as referenced in FIG. 1, etc.) and/or a computing device (e.g., computing device 102 as referenced in FIG. 2, etc.). In some examples, the flow diagram 501 can illustrate different features or components of a computing system. For example, the flow diagram 501 can include a firmware 512, a service 504, and an application 514 to perform particular functions. In some examples, the firmware 512, service 504, and application 514 can be communicatively coupled together such that the firmware 512, service 504, and application 514 are able to communicate through a communication channel.

In some examples, the flow diagram 501 can begin when the service 504 requests a trust token from the firmware 512 at 572. As described herein, the service 504 can be authenticated by the firmware 512. In some examples, the service 504 can initiate the authentication by requesting the trust token from the firmware 512 at 572. In some examples, the firmware 512 can check different features of the service 504 to validate or authenticate the service. For example, the firmware 512 can determine a source or provider of the service 504 and determine if the source or provider of the service 504 is a trusted source or provider for other services.

When the firmware 512 authenticates the service 504 or determines that the service 504 is a trusted service, the firmware 512 can send the service 504 a trust token (t) and a current value of a counter (c) at 574. In some examples, the service 504 can receive the trust token and the current value of the counter along with an encryption key that is a secret between the firmware 512 and the service 504. In some examples, the service 504 can utilize the trust token, current value of the counter, and the encryption key to generate or create an encrypted message at 576. The encrypted message can be generated with a particular format such that the firmware 512 is able to recreate or generate a corresponding encrypted message to later authenticate or validate an encrypted message generated by the service 504. For example, the service 504 can generate an encrypted message with an HMAC (h) as a prefix and a combination of the trust token and current value of the counter (tc) as a suffix. Thus, the encrypted message can include bytes that include an HMAC, trust token, current value to generate (htc).

In some examples, the service 504 can send the encrypted message to the application at 578. As described herein, the encrypted message can be utilized to establish a trusted communication session over a particular communication channel between the service 504 and the application 514. As described herein, the application 514 can relay or forward the encrypted message to the firmware 512 at 580.

The firmware 512 can receive the encrypted message and generate a corresponding HMAC (h′) or corresponding encrypted message at 582. As described herein, the corresponding HMAC or corresponding encrypted message can be generated by the firmware 512 using the same or similar encryption method as the service 504 utilized to generate the encryption message generated at 576. Thus, the firmware 512 is able to compare the HMAC (h) generated at 576 to the corresponding HMAC (h′) to determine whether the HMAC (h) was generated by a trusted service 504 and not a different non-trusted service.

In some examples, the results of the comparison can be sent to the application 514 by the firmware 512 at 584. As described herein, the firmware 512 can send a message, such as an authentication message to the application 514 to indicate a trust status of the service 504. In some examples, the message can instruct the application 514 on how to proceed with the service 504. For example, the message can indicate that the service 504 is a trusted service and a communication session can be established between the application 514 and the service 504. In some examples, the instructions provided by the firmware 512 can be asserted by the application 514 at 586. For example, the application 514 can assert a trust relationship between the application 514 and the service 504 when the firmware 512 authenticated the encrypted message from the service 504.

In this way, the firmware 512 can be utilized to authenticate encrypted messages received by the application 514. This can free up resources associated with the application 514, increase the chain of trust between applications and services, as well as providing for higher levels of manageability and security within the computing system.

The figures herein follow a numbering convention in which the first digit corresponds to the drawing figure number and the remaining digits identify an element or component in the drawing. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure and should not be taken in a limiting sense. Further, as used herein, “a number of” an element and/or feature can refer to any number of such elements and/or features.

What is claimed:

1. A computing device comprising:
a processing resource; and
a memory resource storing instructions thereon, the instructions executable by the processing resource to:
receive, at a service, a token and a current value of a counter from a firmware;
generate, at the service, an encrypted message utilizing the token and the current value;
provide the encrypted message to an application associated with the service;
determine, at the firmware, an authenticity of the encrypted message provided to the application; and
send, from the firmware, a trust status of the service to the application.

2. The computing device of claim 1, wherein the instructions to determine the authenticity of the encrypted message include instructions to generate, at the firmware, a separate encrypted message utilizing the token and the current value of the counter.

3. The computing device of claim 2, wherein the instructions when executed further cause the processing resource to:
compare, at the firmware, the encrypted message received by the application to the separate encrypted message from the firmware.

4. The computing device of claim 3, wherein the trust status of the service is a trusted service when the encrypted message and the separate encrypted message match.

5. The computing device of claim 1, wherein the application is to forward the encrypted message to the firmware before the application is to establish trust with the service.

6. A non-transitory computer-readable storage medium comprising instructions when executed cause a processor of a computing device to:
provide, at a firmware, a token and a current value of a counter to a service to be trusted;
receive, at the firmware, an encrypted message from an application associated with the service, wherein the service is to send the encrypted message to the application;
regenerate, at the firmware, a corresponding encrypted message utilizing the token, the current value of the counter, and the message portion of the encrypted message;
send, from the firmware, an authentication message to the application when the corresponding encrypted message and the encrypted message match.

7. The non-transitory computer-readable storage medium of claim 6, wherein the application is to respond to the encrypted message of the service when the application receives the authentication message from the firmware.

8. The non-transitory computer-readable storage medium of claim 6, wherein the instructions when executed further cause the processing resource to:
update, at the firmware, the current value of the counter when the authentication message is sent to the application.

9. The non-transitory computer-readable storage medium of claim 8, wherein the instructions when executed further cause the processing resource to:
send, from the firmware, a non-authentication message to the application when the corresponding encrypted message and the encrypted message do not match, wherein the non-authentication message indicates that the service is not a trusted service for the application.

10. The non-transitory computer-readable storage medium of claim 6, wherein the token is utilized as a prefix and the current value of the counter is utilized as a suffix for the encrypted message and the corresponding encrypted message.

11. The non-transitory computer-readable storage medium of claim 6, wherein the authentication message includes instructions for the application to allow a communication channel to remain open with the service for a period of time.

12. A system comprising:
a service, comprising instructions executable by a processing resource to:
encrypt a message with a token and a current value of a counter; and
send the encrypted message to an application;
a firmware, comprising instructions executable by the processing resource to:
provide the service with the token and the current value;
receive the encrypted message from the application;
generate a corresponding encrypted message utilizing the token, the current value, and a message portion;
compare the corresponding encrypted message to the encrypted message to determine if the corresponding encrypted message matches the encrypted message;
send a trust status message to the application that indicates an authenticity of the encrypted message;
the application, comprising instructions executable by the processing resource to:
forward the encrypted message from the service to the firmware for authentication;
receive the trust status message from the firmware that indicates the authenticity of the encrypted message; and
continue communication with the service based on the received message from the firmware.

13. The system of claim 12, wherein the instructions to continue communication with the service includes instructions to continue communication with the service for a particular quantity of time.

14. The system of claim 12, wherein the application includes instructions executable by the processing resource to ignore a command associated with the encrypted message when the corresponding encrypted message does not match the encrypted message.

15. The system of claim 12, wherein the service receives the token and the current value of the counter from the firmware.
